(19) United States
(12) Patent Application Publication
(10) Pub. No.: US 2026/0047577 A1
(43) Pub. Date: Feb. 19, 2026

(54) USE OF 1-METHOXYINDOLE FOR REPELLING AND/OR KILLING PESTS

(71) Applicant: Zhejiang University, Hangzhou City (CN)

(72) Inventors: Weiguo FANG, Hangzhou City (CN); Xingyuan TANG, Hangzhou City (CN); Meihong NI, Hangzhou City (CN); Mingxing JIANG, Hangzhou City (CN)

(21) Appl. No.: 19/013,661

(22) Filed: Jan. 8, 2025

(30) Foreign Application Priority Data
Aug. 19, 2024 (CN) 202411137916.1

(51) Int. Cl. A01N 43/38; A01N 25/02; A01P 7/04; A01P 17/00

(52) U.S. Cl. CPC A01N 43/38; A01N 25/02; A01P 7/04; A01P 17/00

(57) ABSTRACT

Use of 1-methoxyindole or derivatives thereof for repelling and/or killing pests is provided, belonging to the technical field of pest control. The active ingredient provided by the present disclosure is 1-methoxyindole (1-MOI), which is a compound found in Metarhizium robertsii. When applied as a repellent, 1-methoxyindole at a concentration of 0.127 μg/cm² in a plane has a repellent effect on a variety of ants, termites, and ticks, and the higher the content of 1-methoxyindole, the better the repellent effect; and when applied as a pesticide, 1-methoxyindole at a concentration of 0.14 μg/cm³ in space has a killing effect on a variety of pests such as ants, termites, ticks, thrips, mosquitoes, Bemisia tabaci, Nilaparvata lugens Stal, and Tetranychus cinnabarinus, and the higher the concentration of 1-methoxyindole, the better the killing effect.

### CROSS REFERENCE TO RELATED APPLICATION

This patent application claims the benefit and priority of Chinese Patent Application No. 2024111379161 filed with the China National Intellectual Property Administration on Aug. 19, 2024, entitled “USE OF 1-METHOXYINDOLE FOR REPELLING AND/OR KILLING PESTS” the disclosure of which is incorporated by reference herein in its entirety as part of the present application.

### TECHNICAL FIELD

The present disclosure belongs to the technical field of pest control, and in particular relates to the use of 1-methoxyindole for repelling and/or killing pests.

### BACKGROUND

Ants, such as Solenopsis invicta Buren, Monomorium pharaonis and Dorylus orientalis, and Coptotermes formosanus are distributed in several countries and regions, seriously endangering agricultural and forestry production, the health of human and livestock, and ecological balance. In addition to affecting people's daily lives, sanitary pests such as Culex pipiens pallens, Anopheles sinensis, Aedes albopictus, Aedes aegypti, Haemaphysalis longicornis, Haemaphysalis concinna, and Cimex lectularius are also important vectors of diseases such as Japanese encephalitis, malaria, dengue fever, and forest encephalitis. In addition, agricultural and stored grain pests such as Bemisia tabaci, Nilaparvata lugens Stal, Tetranychus cinnabarinus, Bactrocera dorsalis, Halyomorpha halys, Megalurothrips usitatus Bagnall, Frankliniella occidentalis Pergande, Thrips alliorum, Orosius orientalis, Tuta absoluta Meyrick, and Tribolium castaneum Herbst affect agricultural production and food storage, causing heavy economic losses. Therefore, pest infestations have become an urgent global issue that needs to be addressed.

Currently, methods for controlling pests mainly include quarantine, physical control, chemical control, and biological control. Chemical control is currently the predominant pest control method due to the significant control effect thereof. However, chemical control methods have problems such as polluting the environment, destroying biological diversity, and causing increased pesticide resistance of pests. Therefore, the research and development of new environmentally friendly pesticides is essential for the chemical control of pests.

In addition, unlike chemical pesticides, the repellents can alleviate the pest infestations suffered by the target by reducing or avoiding contact between pests and the target or can provide early protection for potential targets that may be susceptible to pest infestations. However, the development of pest repellents is still in its infancy, with fewer known effective pest repellent components and high effective concentrations. Therefore, the development of new pest repellents may provide new solutions for pest control.

### SUMMARY

An object of the present disclosure is to provide use of 1-methoxyindole or a derivative thereof for repelling and/or killing pests, so as to exert a repelling and killing effect on a wide variety of pests with a low concentration of active ingredient, which may be used as a repellent and/or pesticide.

The present disclosure provides the use of 1-methoxyindole or a derivative thereof in any one of the following:
S1, repelling and/or killing pests;
S2, preparing a repellent;
S3, preparing a pesticide; and
S4, preparing a product having both repellent and pesticidal capabilities; wherein
the 1-methoxyindole has the structure represented by Formula I:

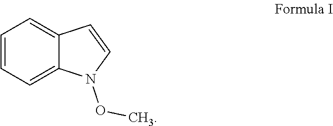 [SMILES: COn1ccc2ccccc21]

In the present disclosure, the applicable subject includes one or more of Hymenoptera insects, Isoptera insects, Diptera insects, Acarina ticks, and Thysanoptera insects.

In the present disclosure, the applicable subject further includes one or more of Cimex lectularius, Periplaneta americana, Blattella germanica, Bemisia tabaci, Nilaparvata lugens Stal, Tetranychus cinnabarinus, Bactrocera dorsalis, Halyomorpha halys, Tribolium castaneum Herbst, Orosius orientalis, and Tuta absoluta Meyrick.

The present disclosure further provides a repellent, comprising a solvent and the 1-methoxyindole described above or a derivative thereof.

The solvent used in the repellent of the present disclosure is an organic solvent.

The solvent used in the repellent of the present disclosure is preferably one of n-hexane, liquid paraffin, and absolute ethanol.

In the present disclosure, by the repellent, the subject to be repelled includes one or more of Hymenoptera insects, Isoptera insects, and Acarina ticks.

In the present disclosure, of the subjects to be repelled by the repellent, the Hymenoptera insects are preferably ants, and the Isoptera insects are preferably termites.

In some embodiments, the ants include one or more of Solenopsis invicta Buren, Dorylus orientalis, Leptogenys kitteli, Tetramorium caespitum, Ochetellus glaber, Ectomomyrmex astutus, Monomorium chinense, Monomorium pharaonis, and Pheidole megacephala.

In some embodiments, the termites include Coptotermes formosanus.

In some embodiments, the ticks include one or more of Haemaphysalis longicornis, and Haemaphysalis concinna.

The present disclosure further provides a pesticide, comprising a solvent and the 1-methoxyindole described above or a derivative thereof.

The solvent used in the pesticide of the present disclosure is an organic solvent.

The solvent used in the pesticide of the present disclosure is preferably one of acetone and liquid paraffin.

In the present disclosure, by the pesticide, the subject to be killed includes one or more of Hymenoptera insects, Isoptera insects, Diptera insects, Acarina ticks, and Thysanoptera insects. The subject to be killed further includes one or more of Cimex lectularius, Periplaneta americana, Blattella germanica, Bemisia tabaci, Nilaparvata lugens Stal, Tetranychus cinnabarinus, Bactrocera dorsalis, Halyomorpha halys, Tribolium castaneum Herbst, Orosius orientalis, and Tuta absoluta Meyrick.

In the present disclosure, of the applicable subjects to be killed by the pesticide, the Hymenoptera insects are preferably ants, the Isoptera insects are preferably termites, the Diptera insects are preferably mosquitoes, and the Thysanoptera insects are preferably thrips.

In some further embodiments, the ants include one or more of Solenopsis invicta Buren, Dorylus orientalis, Leptogenys kitteli, Tetramorium caespitum, Ochetellus glaber, Ectomomyrmex astutus, Monomorium chinense, Monomorium pharaonis, and Pheidole megacephala.

In some embodiments, the termites include Coptotermes formosanus.

In some embodiments, the mosquitoes include one or more of Culex pipiens pallens, Anopheles sinensis, Aedes albopictus, and Aedes aegypti.

In some embodiments, the ticks include one or more of Haemaphysalis longicornis and Haemaphysalis concinna.

In some embodiments, the thrips include one or more of Megalurothrips usitatus Bagnall, Frankliniella occidentalis Pergande, and Thrips palmi.

The present disclosure further provides a product having both repellent and pesticidal capabilities, comprising a solvent and the 1-methoxyindole described above or a derivative thereof.

The present disclosure further provides a method for controlling pests, the method includes controlling pests using the 1-methoxyindole described above or a derivative thereof.

The pests targeted by the method of the present disclosure include sanitary pests, social pests, and agricultural and stored grain pests. In some embodiments, the sanitary pests include one or more of Culex pipiens pallens, Anopheles sinensis, Aedes albopictus, Aedes aegypti, Haemaphysalis longicornis, Haemaphysalis concinna, Cimex lectularius, Periplaneta americana, and Blattella germanica. In some embodiments, the social pests include one or more of Dorylus orientalis worker ants, Leptogenys kitteli worker ants, Tetramorium caespitum worker ants, Ochetellus glaber worker ants, Ectomomyrmex astutus worker ants, Monomorium chinense worker ants, Monomorium pharaonis worker ants, Pheidole megacephala worker ants, and Coptotermes formosanus worker ants. In some embodiments, the agricultural and stored grain pests include one or more of Bemisia tabaci, Nilaparvata lugens Stal, Tetranychus cinnabarinus, Bactrocera dorsalis, Halyomorpha halys, Megalurothrips usitatus Bagnall, Frankliniella occidentalis Pergande, Thrips palmi, Tribolium castaneum Herbst, Orosius orientalis, and Tuta absoluta Meyrick.

In the method for controlling pests of the present disclosure, when the 1-methoxyindole is applied as a repellent, the concentration of the 1-methoxyindole in a plane is 0.127 μg/cm² or more; and when the 1-methoxyindole is applied as a pesticide, the concentration of the 1-methoxyindole in space is 0.14 μg/cm³ or more.

Compared with conventional technology, the present disclosure has the following beneficial effects:

The present disclosure provides the use of 1-methoxyindole or derivatives thereof for repelling and/or killing pests. Specifically, the present disclosure provides a new repellent that can effectively repel ants, termites, and ticks even with low active ingredient content. The present disclosure further provides a new pesticide that can effectively kill a variety of pests even with a low active ingredient concentration, thus providing a new method for preventing and controlling pests. When the 1-methoxyindole in the present disclosure is applied as a repellent, the concentration of the 1-methoxyindole in a plane is 0.127 μg/cm² or more; and when the 1-methoxyindole is applied as a pesticide, the concentration of the 1-methoxyindole in space is 0.14 μg/cm³ or more.

### BRIEF DESCRIPTION OF THE DRAWINGS

FIG. 1 shows a Total Ion Chromatogram (TIC) of volatile compounds in the mycelia in Example 1 in the upper panel; and a TIC of a C₇-C₄₀ normal-alkanes standard in Example 1 in the lower panel;

FIG. 2 shows a mass chromatogram of 1-MOI in the volatile compounds in the mycelia in Example 1;

FIGS. 3A-3C show the schematic diagrams of some of the devices used for testing the repellent effect of a repellent on pests and the effective duration thereof in Example 2, where FIG. 3A is a schematic diagram of a device used for testing the response index of pests to repellents of different concentrations by Two-way-choice in Example 2; FIG. 3B is a schematic diagram of a device used for testing the repellent effect of a repellent on Solenopsis invicta Buren and the effective duration thereof via a barriers method in Example 2; and FIG. 3C is a schematic diagram of a device used for testing the repellent effect of a repellent on Solenopsis invicta Buren via a sand digging method in Example 2, with the left panel being a top view of the device, and the right panel being a side view of the device; and in FIGS. 3A-3C, reference numbers are described as follows: 1-release point, 2-unselected region, 3-1 cm diameter filter paper, 4-9 cm diameter plastic petri dish, 5-ham sausage, 6-test tube, 7-open plastic container, 8-15 cm diameter petri dish, and 9-centrifuge tube;

FIGS. 4A-4I show the results of testing the repellent effect of a 1-MOI repellent on Solenopsis invicta Buren and an effective duration thereof, and the perceptual mechanism of Solenopsis invicta Buren to 1-MOI in Example 2, where FIG. 4A shows the response indices of Solenopsis invicta Buren worker ants to repellents of different concentrations tested by Two-way-choice; FIG. 4B shows the effect of repellents of different concentrations on the foraging behavior of Solenopsis invicta Buren worker ants tested using a wild feeding method; FIG. 4C shows the effect of repellents of different concentrations on the sand digging and nesting behavior of Solenopsis invicta Buren worker ants tested using sand-digging assay; FIG. 4D shows the effect of repellents of different concentrations on the aggressive behavior of Solenopsis invicta Buren worker ants tested via a physical barriers method; FIG. 4E shows the effect of repellents of different concentrations on the foraging behavior of Solenopsis invicta Buren worker ants tested via a physical barriers method; FIG. 4F shows the electroantennogram responses of Solenopsis invicta Buren worker ants to repellents of different 1-MOI concentrations; FIG. 4G shows the effective duration of repellents after volatilization for 5 min at room temperature tested using a physical barriers method; FIG. 4H shows the effective duration of repellents after volatilization for 6 h at room temperature tested using a physical barriers method; and FIG. 4I shows the effective duration of the repellent for affecting the foraging behavior of Solenopsis invicta Buren worker ants tested using a flat filter paper method; and for all the diagrams of FIGS. 4A-4I, different letters indicate significant differences (P<0.05, Mann-Whitney test);

FIGS. 5A-5B show the tests of the killing effect of the 1-MOI pesticide on Solenopsis invicta Buren in Example 3, where FIG. 5A shows the killing effect of pesticides of different concentrations on Solenopsis invicta Buren worker ants tested using a residual film method, and FIG. 5B shows the killing effect of pesticides of different concentrations on Solenopsis invicta Buren worker ants tested using a topical application method, and different letters indicate significant differences (P<0.05, Mann-Whitney test);

FIGS. 6A-6B show the test of the repellent effect of the 1-MOI repellent on Coptotermes formosanus, and the perceptual mechanism of Coptotermes formosanus to 1-MOI in Example 4, where FIG. 6A shows the response indices of Coptotermes formosanus worker ants to repellents of different concentrations tested by Two-way-choice, and FIG. 6B shows the electroantennogram responses of Coptotermes formosanus worker ants to repellents of different concentrations, with different letters indicating significant differences (P<0.05, Mann-Whitney test);

FIGS. 7A-7H show the response indices of various pests to repellents of different 1-MOI concentrations tested by Two-way-choice in Example 5, where FIGS. 7A-7H, in order, respectively show the response indices of Dorylus orientalis worker ants, Leptogenys kitteli worker ants, Tetramorium caespitum worker ants, Ochetellus glaber worker ants, Ectomomyrmex astutus worker ants, Monomorium chinense worker ants, Monomorium pharaonis worker ants, and Pheidole megacephala worker ants to repellents of different 1-MOI concentrations, with different letters indicating significant differences (P<0.05, Mann-Whitney test);

FIGS. 8A-8B show the response indices of ticks to repellents of different 1-MOI concentrations tested by Two-way-choice in Example 6, where FIG. 8A shows the response indices of Haemaphysalis longicornis to repellents of different 1-MOI concentrations, and FIG. 8B shows the response indices of Haemaphysalis concinna to repellents of different 1-MOI concentrations, with different letters indicating significant differences (P<0.05, Mann-Whitney test);

FIGS. 9A-9I show the killing effect of 1-MOI pesticides on sanitary pests tested using a residual film method in Example 7, where FIGS. 9A-9I, in order, respectively show the mortality of Culex pipiens pallens, Anopheles sinensis, Aedes albopictus, Aedes aegypti, Haemaphysalis longicornis, Haemaphysalis concinna, Cimex lectularius, Periplaneta americana, and Blattella germanica after 12 h of treatment with 1-MOI pesticides, with different letters indicating significant differences (P<0.05, Mann-Whitney test);

FIGS. 10A-10I show the killing effect of 1-MOI pesticides on social pests tested using a residual film method in Example 7, where FIGS. 10A-10I, in order, respectively show the mortality of Dorylus orientalis worker ants, Leptogenys kitteli worker ants, Tetramorium caespitum worker ants, Ochetellus glaber worker ants, Ectomomyrmex astutus worker ants, Monomorium chinense worker ants, Monomorium pharaonis worker ants, Pheidole megacephala worker ants, and Coptotermes formosanus worker ants after 12 h of treatment with 1-MOI pesticides, with different letters indicating significant differences (P<0.05, Mann-Whitney test); and

FIGS. 11A-11K show the killing effect of 1-MOI pesticides on agricultural and stored grain pests tested using a residual film method in Example 7, where FIGS. 11A-11K, in order, respectively show the mortality of Bemisia tabaci, Nilaparvata lugens Stal, Tetranychus cinnabarinus, Bactrocera dorsalis, Halyomorpha halys, Megalurothrips usitatus Bagnall, Frankliniella occidentalis Pergande, Thrips palmi, Tribolium castaneum Herbst, Orosius orientalis, and Tuta absoluta Meyrick after 12 h of treatment with 1-MOI pesticides, with different letters indicating significant differences (P<0.05, Mann-Whitney test).

### DETAILED DESCRIPTION OF THE EMBODIMENTS

The present disclosure provides the use of 1-methoxyindole or a derivative thereof in any one of the following:

S1, repelling and/or killing pests;

S2, preparing a repellent;

S3, preparing a pesticide; and
S4, preparing a product having both repellent and pesticidal capabilities; wherein
the 1-methoxyindole (1-MOI) has the structure represented by Formula I:

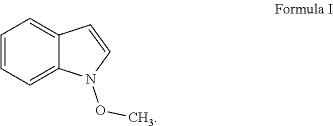 [SMILES: COn1ccc2ccccc21]

The 1-MOI in the present disclosure is produced from a fungus, thus having biosafety to some extent. The 1-MOI in the present disclosure is found in volatile compounds produced by mycelia of a wild-type Metarhizium robertsii ARSEF 2575. With regard to the wild-type Metarhizium robertsii ARSEF 2575 strain, reference can be made to Xu C, Zhang X, Qian Y, Chen X, Liu R, Zeng G, et al. (2014) A High-Throughput Gene Disruption Methodology for the Entomopathogenic Fungus Metarhizium robertsii. PLOS ONE 9(9): e107657. The sources of the 1-MOI are not particularly limited in the present disclosure, as long as it can be prepared by conventional methods in the art or is commercially available.

1-Methoxyindole, abbreviated by 1-MOI, is also known as 1-Methoxy-1H-indole (MFCD18971292).

In the present disclosure, the subject to be repelled includes one or more of Hymenoptera insects, Isoptera insects, and Acarina ticks. Preferably, the Hymenoptera insects are ants, and the Isoptera insects are termites. The ants are preferably one or more of Solenopsis invicta Buren, Dorylus orientalis, Leptogenys kitteli, Tetramorium caespitum, Ochetellus glaber, Ectomomyrmex astutus, Monomorium chinense, Monomorium pharaonis, and Pheidole megacephala. The termite is preferably Coptotermes formosanus. The ticks are preferably Haemaphysalis longicornis and/or Haemaphysalis concinna.

In the present disclosure, the subject to be killed includes one or more of Hymenoptera insects, Isoptera insects, Diptera insects, Acarina ticks, and Thysanoptera insects. Preferably, the Hymenoptera insects are ants, the Isoptera insects are termites, the Diptera insects are mosquitoes, and the Thysanoptera insects are thrips. The ants are preferably one or more of Solenopsis invicta Buren, Dorylus orientalis, Leptogenys kitteli, Tetramorium caespitum, Ochetellus glaber, Ectomomyrmex astutus, Monomorium chinense, Monomorium pharaonis, and Pheidole megacephala. The termite is preferably Coptotermes formosanus. The mosquitoes are preferably one or more of Culex pipiens pallens, Anopheles sinensis, Aedes albopictus, and Aedes aegypti. The ticks are preferably one or more of Haemaphysalis longicornis and/or Haemaphysalis concinna. The thrips are preferably one or more of Megalurothrips usitatus Bagnall, Frankliniella occidentalis Pergande, and Thrips palmi. In some embodiments, the subject to be controlled by the pesticide of the present disclosure further includes one or more of Cimex lectularius, Periplaneta americana, Blattella germanica, Bemisia tabaci, Nilaparvata lugens Stal, Tetranychus cinnabarinus, Bactrocera dorsalis, Halyomorpha halys, Tribolium castaneum Herbst, Orosius orientalis, and Tuta absoluta Meyrick.

The repellent provided by the present disclosure includes a solvent, and the 1-methoxyindole described above or a derivative thereof. When used as a repellent, the solvent used is an organic solvent. The organic solvent is preferably one of n-hexane, liquid paraffin, and absolute ethanol.

The pesticide provided by the present disclosure includes a solvent, and the 1-methoxyindole described above or a derivative thereof. When used as a pesticide, the solvent used is an organic solvent. The organic solvent is preferably one of acetone and liquid paraffin.

The method for controlling pests of the present disclosure can control pests by using the 1-methoxyindole described above or a derivative thereof. The pests targeted by the method of the present disclosure include sanitary pests, social pests, and agricultural and stored grain pests. Specifically, the sanitary pests are preferably one or more of Culex pipiens pallens, Anopheles sinensis, Aedes albopictus, Aedes aegypti, Haemaphysalis longicornis, Haemaphysalis concinna, Cimex lectularius, Periplaneta americana, and Blattella germanica. The social pests are preferably one or more of Dorylus orientalis worker ants, Leptogenys kitteli worker ants, Tetramorium caespitum worker ants, Ochetellus glaber worker ants, Ectomomyrmex astutus worker ants, Monomorium chinense worker ants, Monomorium pharaonis worker ants, Pheidole megacephala worker ants, and Coptotermes formosanus worker ants. The agricultural and stored grain pests are preferably one or more of Bemisia tabaci, Nilaparvata lugens Stal, Tetranychus cinnabarinus, Bactrocera dorsalis, Halyomorpha halys, Megalurothrips usitatus Bagnall, Frankliniella occidentalis Pergande, Thrips palmi, Tribolium castaneum Herbst, Orosius orientalis, and Tuta absoluta Meyrick.

In the method for controlling pests of the present disclosure, when the 1-methoxyindole is applied as a repellent, the concentration of the 1-methoxyindole in a plane is 0.127 μg/cm² or more; and when the 1-methoxyindole is applied as a pesticide, the concentration of the 1-methoxyindole in space is 0.14 μg/cm³ or more.

In the present disclosure, with regard to the wild-type Metarhizium robertsii ARSEF 2575, reference can be made to the following document: Xu C, Zhang X, Qian Y, Chen X, Liu R, Zeng G, et al. (2014) A High-Throughput Gene Disruption Methodology for the Entomopathogenic Fungus Metarhizium robertsii. PLOS ONE 9 (9): e107657.

In the present disclosure, the Solenopsis invicta Buren was sponsored by Professor Jiang Mingxing in Zhejiang University, the Haemaphysalis longicornis was sponsored by Professor Wang Jingwen in Fudan University, the Cimex lectularius was sponsored by Professor Wang Desen in South China Agricultural University, the Bemisia tabaci was sponsored by Professor Wang Xiaowei in Zhejiang University, the Nilaparvata lugens Stal was sponsored by Professor Xu Haijun in Zhejiang University, the Haemaphysalis concinna and Aedes aegypti were sponsored by researcher Tang Xiaotian in Zhejiang University, the Orosius orientalis was sponsored by professor Xu Yi in Nanjing Agricultural University, and the Tuta absoluta Meyrick was sponsored by professor Zhang Jin in Nanjing Agricultural University. All the other pests were sourced from laboratory breeding or commercially available.

In the following examples, the test pests used, except for the Tuta absoluta Meyrick which is a larva, were all adult pests.

Unless otherwise specified, the test methods used in the examples below are all conventional methods. In addition, unless otherwise specified, the materials, reagents, etc., used are those commercially available.

The technical solutions of the present disclosure will be described clearly and completely below in conjunction with examples of the present disclosure.

### Example 1

### Discovery of 1-MOI

### 1. Test Method

### (1) Solid Phase Microextraction (SPME)

0.1 gram mycelia of fresh weight of wild-type Metarhizium robertsii ARSEF 2575 that was stored in the laboratory, was weighed and put in a glass injection vial with a volume of 20 mL. The vial was capped, then a 50/30 μm DVB/CAR/PDMS solid phase microextraction fiber was inserted into the injection vial for extraction at 40° C. for 50 min.

### (2) SPME-GC-MS Analysis

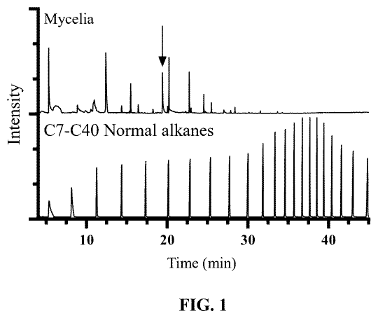

After the solid phase microextraction was completed, the sample was manually injected from the injection port into the instrument, resolved for 3 min, and analyzed using a DB-5 MS (30 m×0.25 mm, 0.25 μm) chromatography column, with the temperature of the injection port being 250° C. The GC-MS procedures were as follows: onset temperature 40° C., holding for 2 min; and heating at 5° C./min to 180° C., then heating at 10° C./min to 270° C. and holding for 10 min. The total ion chromatogram (TIC) as shown in the upper panel in FIG. 1 in combination with the mass spectra data of the chromatographic peaks in FIG. 2 were aligned with those in the NIST05 mass spectrum library to make a preliminary prediction of the compound characterized by the chromatographic peak. According to the compound CAS No. provided by the mass spectrum library, a chemically synthesized standard was purchased. The standard was subjected to GC-MS analysis together with a C₇-C₄₀ normal-alkanes standard according to the procedure described above. The result was shown in FIG. 1, and a Linear Retention Index (LRI) was calculated according to an equation below: LRIₓ=100×z+100×(RTₓ−RT_{z})/(RT_{z+1}−RT_{z}), where “x” indicates the substance whose RI to be calculated, “z” indicates the closest n-alkane whose retention time is before x, and “z+1” indicates the closest n-alkane whose retention time is after x. According to the retention index, it was determined that the compound 1-MOI in the volatile compounds produced by mycelia was the same as the 1-MOI standard.

### 2. Results

After the GC-MS analysis, it was found that in the volatile compounds produced by the wild-type Metarhizium robertsii mycelia, the compound peak at the retention time (RT)=19.24 min shown in the upper panel in FIG. 1 had a mass spectrum as shown in FIG. 2. This compound was predicted to be 1-methoxyindole (1-MOI) according to the NIST05 database. According to the CAS No. (CAS: 54698-11-2) from the database, a chemically synthesized standard was purchased. The standard had a RT=19.24 min, which was the same as the RT of the substance in the volatile compounds produced by the wild-type Metarhizium robertsii mycelia and was between the RT of n-dodecane and the RT of n-tridecane. Thus, upon calculation, LRI=100×12+100×(19.24−17.35)/(20.18−17.35)=1266, such that the substance was determined as 1-MOI.

TABLE 1
Linear retention index of 1-MOI produced by mycelia and 1-MOI standard
Linear retention index

| 1-MOI produced | |
|---|---|
| by mycelia | 1-MOI standard |
| 1266 | 1266 |

### Example 2

### Repellent Effect of Repellent on Solenopsis invicta Buren and Effective Duration Thereof and Electroantennogram Response of Solenopsis invicta Buren to 1-MOI

### 1. Test Method

(1) Detection of Repellent Effect of Repellents on Solenopsis invicta Buren Worker Ants by Two-Way-Choice Test

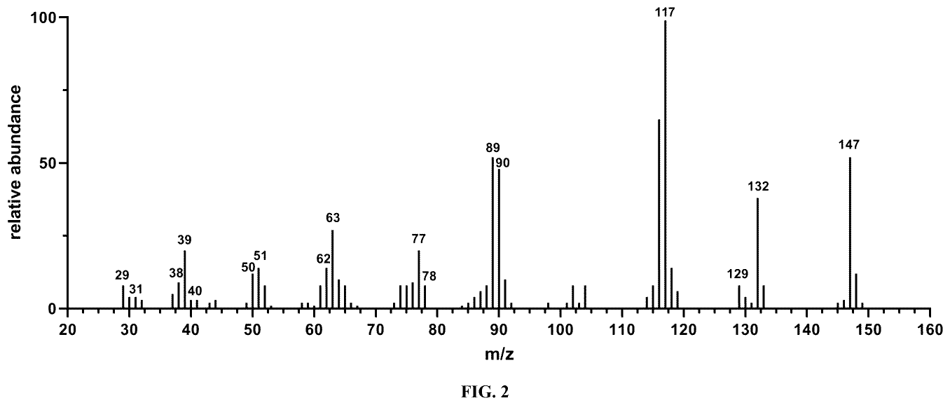

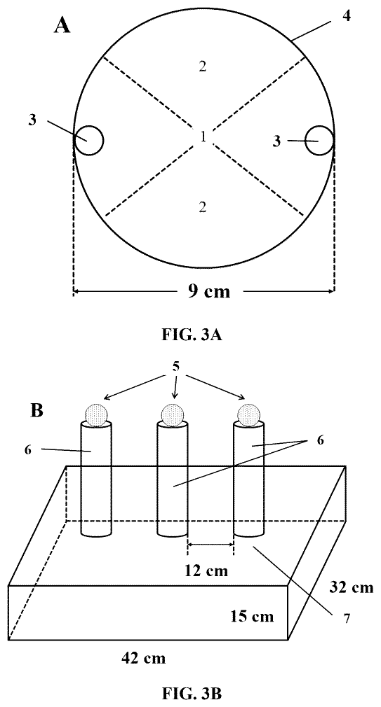

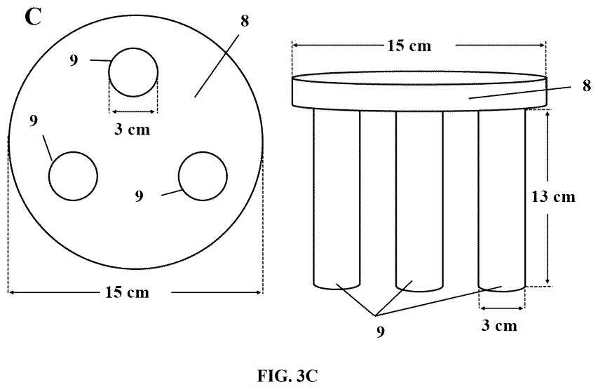

Repellents with a 1-MOI concentration of 10⁻³ g/mL, 10⁻⁴ g/mL, 10⁻⁵ g/mL, 10⁻⁶ g/mL, 10⁻⁷ g/mL, 10⁻⁸ g/mL, and 10⁻⁹ g/mL were prepared for Two-way choice tests, with n-hexane being used as a solvent. The device shown in FIG. 3A was used; two circular filter paper having a diameter of 1 cm were respectively placed at both ends of a plastic petri dish with a diameter of 9 cm; 10 μL of repellents of different concentrations and a solvent of n-hexane were respectively dropwise added thereto, with n-hexane as a control; and the petri dish was open and the filter paper were left to volatilize at room temperature for 2 min. 20 healthy Solenopsis invicta Buren worker ants were placed at the center of the petri dish and their choices were recorded after 10 min. The response index was calculated: response index=(number of worker ants choosing filter paper with repellent droplets-number of worker ants choosing filter paper with n-hexane droplets)/total number of the worker ants. The repellent effect of each concentration of repellent on Solenopsis invicta Buren worker ants was repeatedly tested at least six times.

(2) Test of Repellent Effect of Repellents on Solenopsis invicta Buren Worker Ants Using a Field Feeding Method.

Repellents with different concentrations of 1-MOI (total amount of 1-MOI in a sponge block being 3 μg, 30 μg, and 300 μg) were prepared for later use using liquid paraffin as a solvent. At an external temperature of about 26° C., 1 g of ham sausage and a sponge block with a volume of 1 cm³ were both placed in 2 transparent plastic bottles with a volume of 50 mL. 300 μL of a repellent was added dropwise to the sponge block in one plastic bottle, and the same volume of liquid paraffin was added dropwise to the sponge block in the other plastic bottle as a control. The bottles were arranged with the bottle mouth facing a Solenopsis invicta Buren anthill, and after 30 min, the number of the worker ants feeding the ham sausage in two plastic bottles were counted.

(3) Test of Repellent Effect of Repellents on Solenopsis invicta Buren Worker Ants Using Sand Digging Method

Repellents with different concentrations of 1-MOI were prepared for later use using liquid paraffin as a solvent. The device as shown in FIG. 3C was used; 3 circular holes that could accommodate the insertion of a 50 mL centrifuge tube were evenly punched at the bottom of a circular petri dish with a diameter of 15 cm; the 3 centrifuge tubes were filled with 40 mesh-size fine sand mixed with 10 mL of different solutions (sterile water, liquid paraffin, and 1-MOI repellent), respectively as different treatments (with the concentration of 1-MOI in fine sand being set as 2×10⁻⁴ g/kg, 2×10⁻³ g/kg, 2×10⁻² g/kg, and 2×10⁻¹ g/kg, respectively), with the weight of fine sand being 50 g (W1); and the centrifuge tubes were inserted into the circular petri dish through the holes with the mouth of the tubes just flush with the bottom of the petri dish. 200 Solenopsis invicta Buren worker ants were placed in the center of the petri dish, and the weight (W2) of the remaining fine sand in each centrifuge tube was weighed after 12 h to calculate the sand transferring ratio (%)=(W1−W2)/W1×100%. The repellent effect of each concentration of repellent on Solenopsis invicta Buren worker ants was repeatedly tested at least six times.

(4) Test of Repellent Effect of Repellents on Solenopsis invicta Buren Worker Ants Using a Barrier Method

Based on the aggressive behavior and foraging behavior of the Solenopsis invicta Buren worker ants, a barrier method was designed to test the repellent effect of repellents on Solenopsis invicta Buren, and the device used was shown in FIG. 3B. Repellents with a concentration of 10⁻¹ g/mL, 10⁻² g/mL, 10⁻³ g/mL, 10-+g/mL, 10⁻⁵ g/mL, and 10⁻⁶ g/mL were prepared for repellent effect tests, with liquid paraffin being used as a solvent. In order to compare the repellent effect of the repellent provided by the present disclosure with the widely used broad-spectrum insect repellent DEET (N,N-diethyl-trimethyl-benzamide) on Solenopsis invicta Buren worker ants, a 40% concentration of DEET solution was prepared for later use simultaneously. 500 μL of liquid paraffin, 40% DEET solution, and repellents with different concentrations of 1-MOI as described above were sprayed uniformly on clean circular white filter paper with a diameter of 9 cm, respectively, with the concentration of 1-MOI in the filter paper being 0.00786 μg/cm², 0.0786 μg/cm², 0.786 μg/cm², 7.86 μg/cm², 78.6 μg/cm², and 786 μg/cm²; and after standing for 5 min, the filter paper was respectively wrapped around the outer walls of 8 mL glass test tubes. A Solenopsis invicta Buren anthill excavated in the field as a whole was placed in an open plastic container measuring 45 cm×32 cm×15 cm. The 3 glass test tubes described above were inserted 12 cm apart into the anthill with a depth of about 2 cm, and the number of worker ants that climbed onto the test tube to attack was counted within 1 minute after insertion.

After 30 min, the ant population was stabilized and stopped attacking, 1 g of ham sausage was placed on the top of the glass test tubes, and the number of worker ants feeding the ham sausage across the repellent barrier was counted after 30 min.

(5) Detection of Electroantennogram Responses of Solenopsis invicta Buren Worker Ants to 1-MOI

Repellents with a 1-MOI concentration of 10⁻² g/mL, 10⁻³ g/mL, 10-+g/mL, 10⁻⁵ g/mL, 10⁻⁶ g/mL, and 10⁻⁷ g/mL were prepared for later use, with n-hexane being used as a solvent. 1 cm² filter paper was placed in a clean pipette tip of 1000 μL, and 10 μL of repellents of different concentrations were dropped onto the filter paper, bringing the total amount of 1-MOI in the filter paper to 10⁻⁴ g, 10⁻⁵ g, 10⁻⁶ g, 10⁻⁷ g, 10⁻⁸ g, and 10⁻⁹ g, respectively. The antennas of Solenopsis invicta Buren worker ants were pinched off from the middle with pointed tweezers, and the tips of the antennas were broken with the pointed tweezers, thus facilitating the normal conduction of electrical signals. The two ends of the antennas were fixed onto the two electrodes of the electroantennogram detector with conductive glue; after the baseline of the electroantennogram signal stabilized, the antennas were simulated sequentially with gas streams of repellents of different concentrations described above in an ascending order of content every 15 seconds, and the values of the nerve impulse signal generated by the antennas were then recorded. The n-hexane as a negative control was tested at the beginning and end of each repetition, and the signal values were recorded. The repellent of each concentration was tested in succession with 10 antennas of different worker ants.

(6) Detection of Repellent Effective Duration of Repellents on Solenopsis invicta Buren Worker Ants Based on Physical Barriers Method

Based on the physical barriers method described above, a 1-MOI repellent at a concentration of 100 mg/mL and a DEET solution at a concentration of 100 mg/mL were prepared using absolute ethanol as a solvent; 500 μL of absolute ethanol, the 1-MOI repellent, and the DEET solution were respectively sprayed uniformly on clean circular white filter paper with a diameter of 9 cm, left to volatilize at room temperature for 5 min and 6 h, respectively, then the white filter paper was wrapped around 8 mL glass test tubes; 3 test tubes were inserted 12 cm apart into the anthill with a depth of 2 cm; 1 g of ham sausage was placed on top of the test tubes; and the number of worker ants feeding the ham sausage across the repellent barrier was counted every 1 h.

(7) Detection of Repellent Effective Duration of Repellents on Solenopsis invicta Buren Using Flat Filter Paper Method

A 1-MOI repellent at a concentration of 100 mg/mL and a 100 mg/mL DEET solution were prepared using absolute ethanol as a solvent; 500 μL of absolute ethanol, the repellent, and the DEET solution were respectively sprayed uniformly on clean circular white filter paper with a diameter of 9 cm and left to volatilize at room temperature for 5 min; then 1 g of ham sausage was placed in the center of the filter paper; 3 pieces of the filter paper were placed 10 cm apart on the surface of the anthill; and the number of worker ants feeding the ham sausage on the 3 pieces of filter paper was counted after 2 h.

### 2. Results

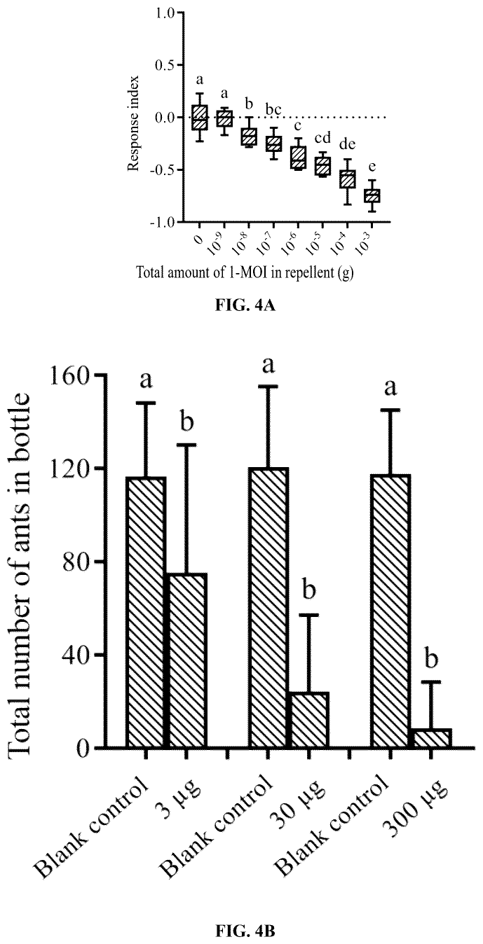

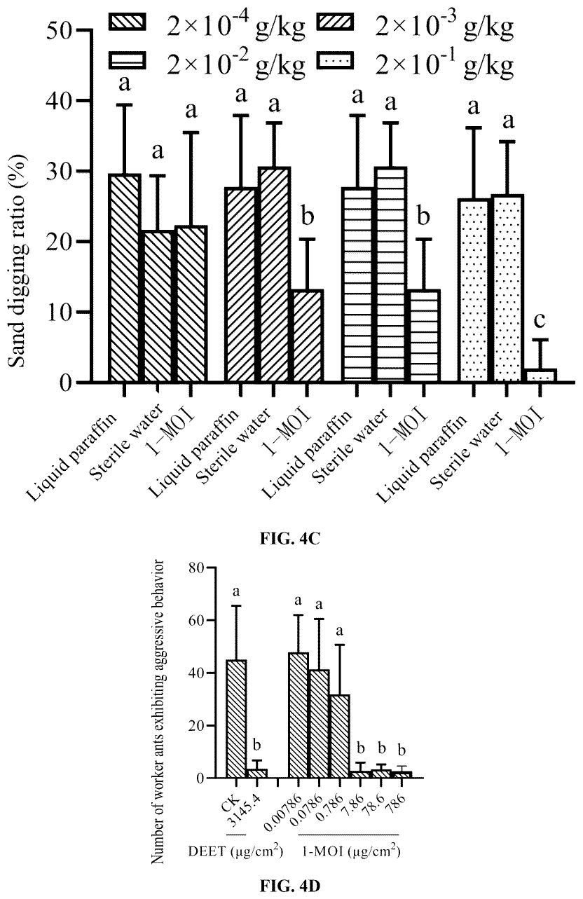

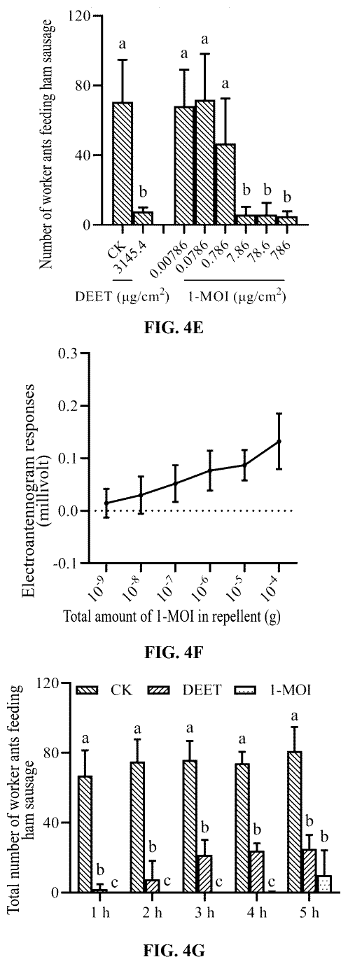

(1) The results of Two-way-choice test show that after application of the repellent, a repellent effect is observed for Solenopsis invicta Buren worker ants when the total amount of 1-MOI is 10⁻⁸ g-10⁻³ g, and the higher the concentration of 1-MOI, the better the repellent effect (FIG. 4A).
(2) The results of the test using a field feeding method show that when the total amount of 1-MOI in the sponge block is 3 μg, 30 μg, and 300 μg, the number of Solenopsis invicta Buren worker ants in the plastic bottles is significantly less than that of the control group, and the higher the concentration of 1-MOI, the better the inhibitory effect on the foraging behavior of worker ants, indicating that the worker ants are repelled (FIG. 4B).
(3) The results of the test using a sand digging method show that when the concentration of 1-MOI in fine sand is 2×10⁻⁴ g/kg, 2×10⁻³ g/kg, 2×10⁻² g/kg, and 2×10⁻¹ g/kg, the sand transferring ratios of Solenopsis invicta Buren worker ants are significantly lower than those of the other two treatments, and the higher the concentration, the better the inhibitory effect on sand-digging and nesting behaviors of worker ants, indicating that the worker ants are repelled (FIG. 4C).
(4) The results of the test using a barrier method show that compared to the control group, when the concentration of 1-MOI in a filter paper is 7.86 μg/cm², 78.6 μg/cm², and 786 μg/cm², the number of Solenopsis invicta Buren worker ants climbing the test tube for attack is significantly reduced, and there is no significant difference between the repellent-effect of 7.86 μg/cm² 1-MOI and 3145.4 μg/cm² DEET (FIG. 4D).

Moreover, when the concentration of 1-MOI in a filter paper is 7.86 μg/cm², 78.6 μg/cm², and 786 μg/cm², the number of Solenopsis invicta Buren worker ants feeding the ham sausage across barriers is significantly reduced, and there is no significant difference between the repellent-effects of 7.86 μg/cm² 1-MOI and 3145.4 μg/cm² DEET (FIG. 4E). The above results show that the required 1-MOI concentration is 1/400 of the DEET when exerts the same repellent effect.
(5) The results of the electroantennogram test show that when the total amount of 1-MOI in the repellent is 10⁻⁴ g, 10⁻⁵ g, 10⁻⁶ g, 10⁻⁷ g, 10⁻⁸ g, and 10⁻⁹ g, it all can cause the electroantennogram responses of Solenopsis invicta Buren worker ants, in addition, as the total amount of 1-MOI increases, the electroantennogram responses increase accordingly, indicating that 1-MOI is perceived by Solenopsis invicta Buren worker ants through the olfactory system and has an effect on their behaviors (FIG. 4F).
(6) The results of the repellent effective duration test using a physical barriers method show that when the 1-MOI repellent is left to volatilize at room temperature for 5 min and then applied to the anthill, the numbers of worker ants feeding the ham sausage across barriers are all significantly lower than those of the blank control group and significantly lower than those of the DEET-applied group within 4 h; moreover, at the 5th hour, the numbers of worker ants feeding with the ham sausage in the 1-MOI-applied group are not significantly different from the DEET group, and both groups are significantly lower than those of the control group, indicating that the repellent effect is better retained within 5 h when 1-MOI repellent is applied in this manner, and the repellent effect is superior to DEET within 4 h (FIG. 4G).

In addition, when the 1-MOI repellent is left to volatilize at room temperature for 6 h before being applied to the anthill, the numbers of worker ants feeding the ham sausage across barriers are all significantly lower than those of the control group within 4 h. The numbers of worker ants feeding the ham sausage in the 1-MOI-applied group are all significantly lower than those of the DEET group within 2 h, and there is no significant difference therebetween after 2 h, indicating that when the 1-MOI repellent is applied in this way, the repellent effect is better retained within 4 h, and the repellent effect is superior to DEET within 2 h (FIG. 4H).
(7) The results of the repellent effective duration test using a flat filter paper method show that the numbers of worker ants feeding the ham sausage on a 1-MOI repellent-applied filter paper are all significantly less than those in the control group and the DEET-applied group within 2 h, indicating that when 1-MOI repellent is applied in this way, the repellent effect on Solenopsis invicta Buren is well retained within 2 h and superior to DEET (FIG. 4I).

### Example 3

### Killing Effect of 1-MOI Pesticides on Solenopsis invicta Buren

### 1. Test Method

(1) Test of Killing Effect of 1-MOI Pesticides on Solenopsis invicta Buren Worker Ants Using Residual Film Method

Pesticides of different 1-MOI concentrations (with the concentration of 1-MOI in space being 0.14 μg/cm³, 0.28 μg/cm³, and 1.4 μg/cm³, respectively) were prepared using acetone as a solvent; a cotton ball dropwise added with 0.5 mL 2.5% aqueous solution of sucrose was put in a 350 mL plant tissue culture flask as the water source and food for the Solenopsis invicta Buren; and talc powder was applied to the mouth of the flask to prevent the Solenopsis invicta Buren from escaping. 1 mL of a repellent was added dropwise to the side wall of the tissue culture flask, and the tissue culture flask was rotated to allow the pesticide evenly distributed on the side wall; after acetone completely volatilized, 20 healthy Solenopsis invicta Buren worker ants were placed in the flask and sealed; and after 12 h, the number of dead Solenopsis invicta Buren worker ants was counted, and the mortality rate (%) was calculated, with the mortality rate (%)=number of dead Solenopsis invicta Buren worker ants/total number of Solenopsis invicta Buren worker ants×100%. The test of the killing effect of the repellent at each concentration was repeated at least six times.

(2) Test of Killing Effect of Pesticides on Solenopsis invicta Buren Worker Ants Using Topical Application Method

Pesticides with different 1-MOI concentrations (with the total amount of 1-MOI being 0.01 μg, 0.1 μg, 1 μg, and 10 μg) were prepared using liquid paraffin as a solvent, 1 μL of a pesticide was topically applied onto the pronotum of a Solenopsis invicta Buren worker ant, then the worker ant was transferred to a plastic bug box, with the repellent of each concentration of 1-MOI being topically applied onto 15 worker ants. A cotton ball dropwise added with 0.5 mL 2.5% aqueous solution of sucrose was put in the plastic box as the water source and food, and after 48 h, the number of dead Solenopsis invicta Buren worker ants was counted and the mortality rate was calculated, with the mortality rate (%)=number of dead Solenopsis invicta Buren worker ants/total number of Solenopsis invicta Buren worker ants×100%. Solenopsis invicta Buren worker ants topically applied with liquid paraffin were used as the control group, with each pesticide concentration of 1-MOI repeated 6 times.

### 2. Results

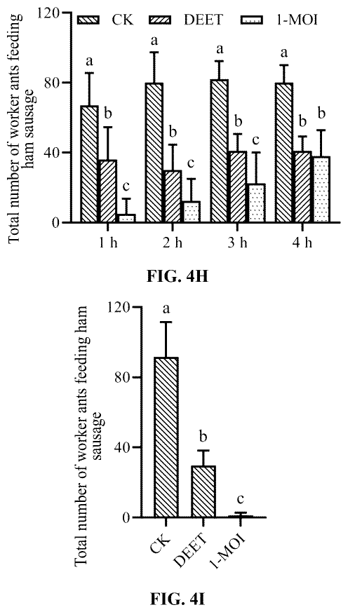

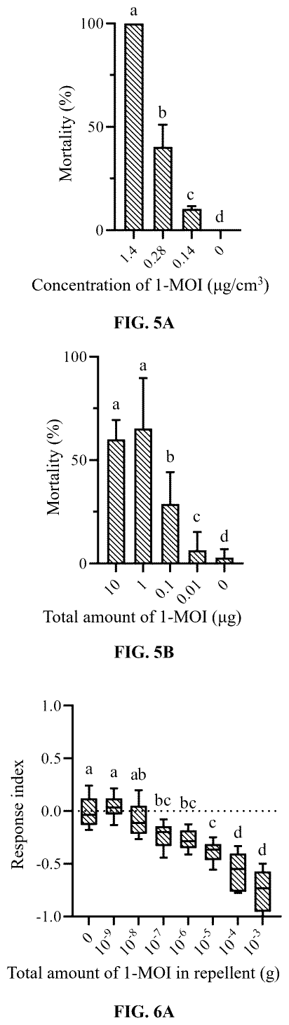

(1) The results of the test using a residual film method show that a killing effect of 25% is observed for Solenopsis invicta Buren worker ants when the concentration of 1-MOI is 0.14 μg/cm³ in space; a killing effect of 65% is observed for Solenopsis invicta Buren worker ants when the concentration of 1-MOI is 0.28 μg/cm³; and a killing effect of 100% is observed for Solenopsis invicta Buren worker ants when the concentration of 1-MOI is 1.4 μg/cm³ (FIG. 5A).
(2) The results of the test using a topical application method show that when the total amount of 1-MOI in the pesticide topically applied to the pronotum of Solenopsis invicta Buren worker ants is 0.01 μg, the mortality rate of the Solenopsis invicta Buren worker ants is 6%; when the total amount is 0.1 μg, the mortality rate is 28%; and when the total amount is 1 μg and 10 μg, the mortality rates are higher than 60% (FIG. 5B).

### Example 4

### Repellent Effect of 1-MOI Repellents on Coptotermes formosanus and Electroantennogram Responses of Coptotermes formosanus to 1-MOI

### 1. Test Method

(1) Detection of Repellent Effect of 1-MOI Repellents on Coptotermes formosanus Worker Ants by Two-Way-Choice Test:

The test method was the same as that in (1) of Example 2, except that the Solenopsis invicta Buren worker ants were replaced with Coptotermes formosanus worker ants.

(2) Detection of Electroantennogram Responses of Coptotermes formosanus to 1-MOI

The test method was the same as that in (5) of Example 2, except that the Solenopsis invicta Buren worker ants were replaced with Coptotermes formosanus worker ants.

### 2. Results

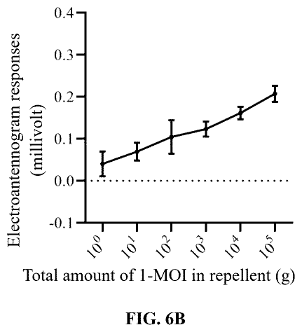

(1) The results of Two-way-choice test show that after application of the repellent, a repellent effect is observed for Coptotermes formosanus worker ants when the total amount of 1-MOI is 10⁻⁷ g-10⁻³ g, and the higher the total amount of 1-MOI, the better the repellent effect (FIG. 6A).
(2) The results of the electroantennogram test show that when the total amount of 1-MOI in the repellent is 10⁻⁴ g, 10⁻⁵ g, 10⁻⁶ g, 10⁻⁷ g, 10⁻⁸ g, and 10⁻⁹ g, it can all cause the electroantennogram responses of Coptotermes formosanus worker ants. In addition, as the total amount of 1-MOI increases, the electroantennogram responses increase accordingly, indicating that 1-MOI is perceived by Coptotermes formosanus worker ants through the olfactory system, which has an effect on their behaviors (FIG. 6B).

### Example 5

### Repellent Effect of 1-MOI Repellents on Dorylus orientalis, Leptogenys kitteli, Tetramorium caespitum, Ochetellus glaber, Ectomomyrmex astutus, Monomorium chinense, Monomorium pharaonis, and Pheidole megacephala

### 1. Test Method

The repellent effect of the 1-MOI repellent on Dorylus orientalis, Leptogenys kitteli, Tetramorium caespitum, Ochetellus glaber, Ectomomyrmex astutus, Monomorium chinense, Monomorium pharaonis, and Pheidole megacephala by Two-way-choice test was specifically implemented according to the same method as that in (1) of Example 2.

### 2. Results

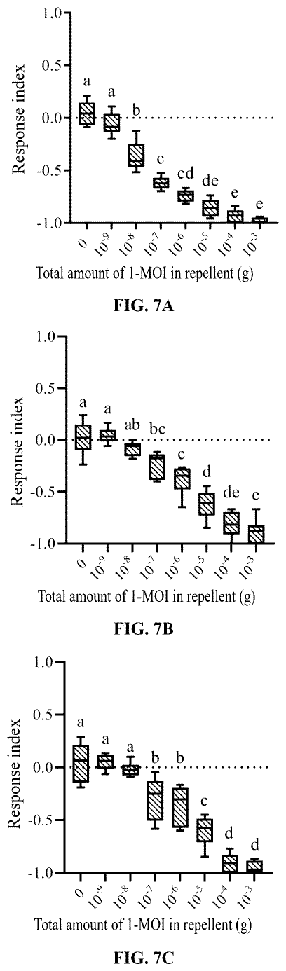

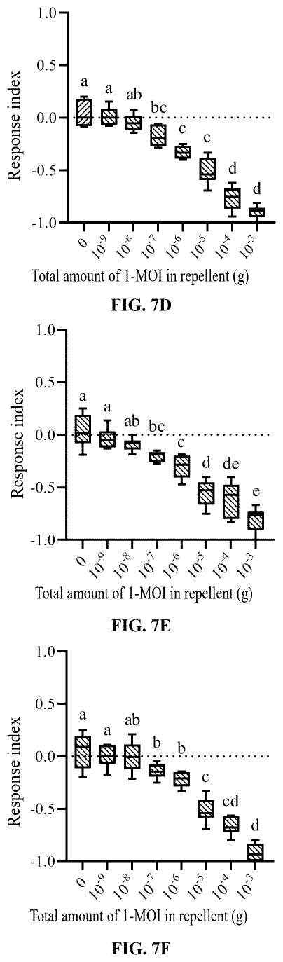

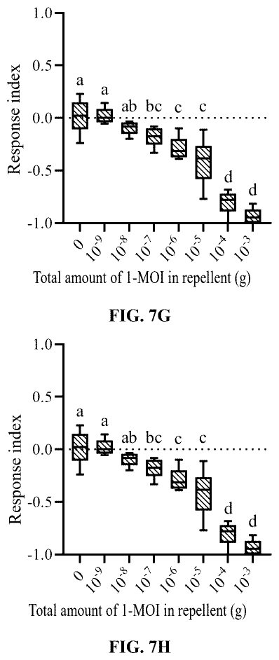

(1) After application of the repellent, a repellent effect is observed for Dorylus orientalis worker ants when the total amount of 1-MOI is 10⁻⁸ g-10⁻³ g, and the higher the total amount of 1-MOI, the better the repellent effect (FIG. 7A).
(2) In FIGS. 7B-7H show the response indices of Dorylus orientalis worker ants, Leptogenys kitteli worker ants, Tetramorium caespitum worker ants, Ochetellus glaber worker ants, Ectomomyrmex astutus worker ants, Monomorium chinense worker ants, Monomorium pharaonis worker ants, and Pheidole megacephala worker ants sequentially to repellents of different concentrations of 1-MOI. Repellent effects are observed for Leptogenys kitteli worker ants, Tetramorium caespitum worker ants, Ochetellus glaber worker ants, Ectomomyrmex astutus worker ants, Monomorium chinense worker ants, Monomorium pharaonis worker ants, and Pheidole megacephala worker ants when the total amount of 1-MOI is 10⁻⁷ g-10⁻³ g, and the higher the total amount of 1-MOI, the better the repellent effect.

### Example 6

### Repellent Effect of Repellents on Haemaphysalis longicornis and Haemaphysalis concinna

### 1. Test Method

The repellent effect of the 1-MOI repellent on Haemaphysalis longicornis and Haemaphysalis concinna by Two-way-choice test were specifically implemented according to the same method as that in (1) of Example 2.

### 2. Results

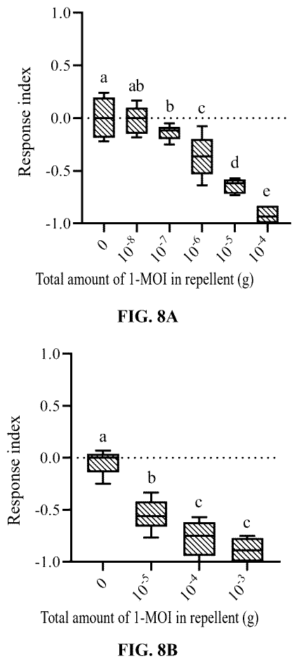

After application of the repellent, a repellent effect is observed for Haemaphysalis longicornis when the total amount of 1-MOI is 10⁻⁷ g-10⁻³ g, and the higher the total amount of 1-MOI, the better the repellent effect (FIG. 8A); and a repellent effect is observed for Haemaphysalis concinna when the total amount of 1-MOI is 10⁻⁵ g-10⁻³ g, and the higher the total amount of 1-MOI, the better the repellent effect (FIG. 8B).

### Example 7

### Pest Killing Effect of 1-MOI Pesticides

### 1. Killing Effect of 1-MOI Pesticides on Sanitary Pests

### (1) Test Method

The killing effect of the 1-MOI pesticide on Culex pipiens pallens, Anopheles sinensis, Aedes albopictus, Aedes aegypti, Haemaphysalis longicornis, Haemaphysalis concinna, Cimex lectularius, Periplaneta americana, and Blattella germanica using a residual film method was specifically implemented according to the same method as the test method (1) in Example 3.

### (2) Results

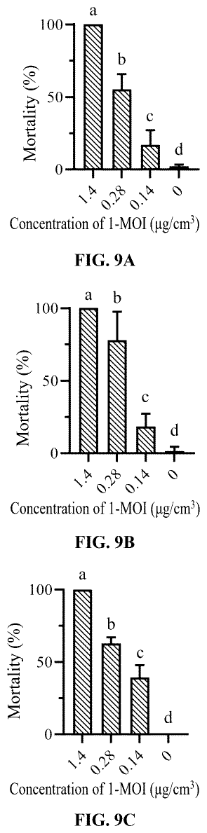

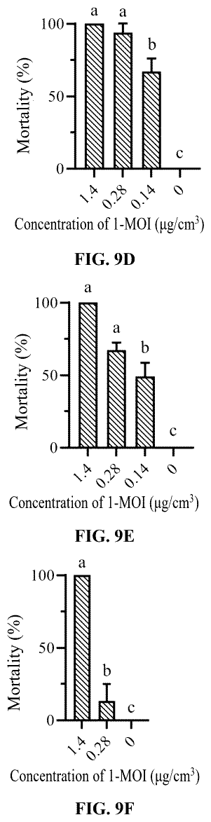

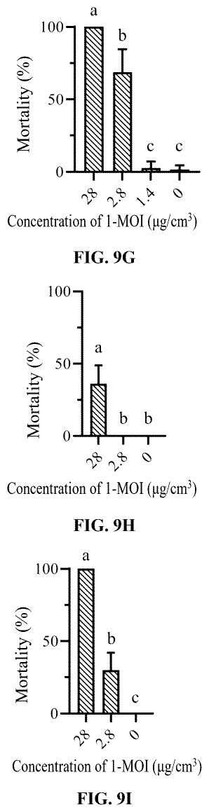

The results of the tests using a residual film method are shown in FIGS. 9A-9I. FIGS. 9A-9I, in order, respectively show the mortality rate of Culex pipiens pallens, Anopheles sinensis, Aedes albopictus, Aedes aegypti, Haemaphysalis longicornis, Haemaphysalis concinna, Cimex lectularius, Periplaneta americana, and Blattella germanica after 12 h of treatment with the 1-MOI pesticides. After application of the pesticide at a concentration of 0.14 μg/cm³ in space, 17%, 18%, 39%, 67%, and 49% of Culex pipiens pallens, Anopheles sinensis, Aedes albopictus, Aedes aegypti, and Haemaphysalis longicornis were killed, respectively; when the concentration of 1-MOI was 0.28 μg/cm³ in space, 55%, 78%, 63%, 93%, 67%, and 13% of Culex pipiens pallens, Anopheles sinensis, Aedes albopictus, Aedes aegypti, Haemaphysalis longicornis, and Haemaphysalis concinna were killed, respectively; and when the concentration of 1-MOI was 1.4 μg/cm³ in space, 100% of Culex pipiens pallens, Anopheles sinensis, Aedes albopictus, Aedes aegypti, Haemaphysalis longicornis, and Haemaphysalis concinna were killed. When the concentration of 1-MOI was 2.8 μg/cm³ in space, 68% and 30% Cimex lectularius and Blattella germanica were killed, respectively; and when the concentration was 28 μg/cm³ in space, 100% Cimex lectularius and Blattella germanica were killed, and 36% Periplaneta americana were killed.

### 2. Killing Effect of 1-MOI Pesticides on Social Pests

### (1) Test Method

The killing effect of the 1-MOI pesticide on Dorylus orientalis, Leptogenys kitteli, Tetramorium caespitum, Ochetellus glaber, Ectomomyrmex astutus, Monomorium chinense, Monomorium pharaonis, Pheidole megacephala, and Coptotermes formosanus using a residual film method was specifically implemented according to the same method as the test method (1) in Example 3.

### (2) Results

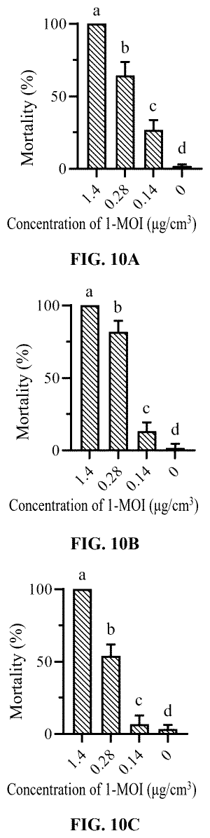

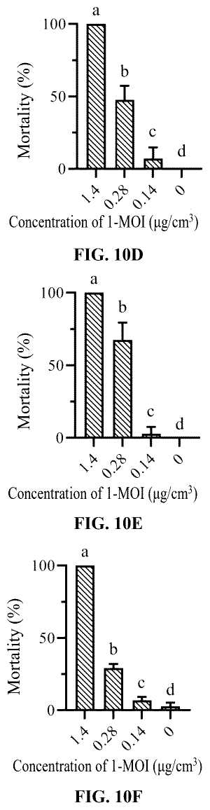

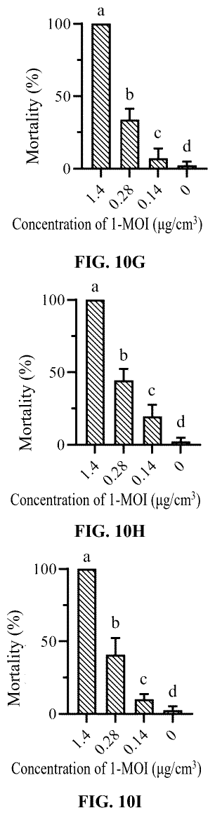

The results of the tests using a residual film method are shown in FIGS. 10A-10I. In FIGS. 10A-10I, in order, respectively correspond to the mortality rate of Dorylus orientalis worker ants, Leptogenys kitteli worker ants, Tetramorium caespitum worker ants, Ochetellus glaber worker ants, Ectomomyrmex astutus worker ants, Monomorium chinense worker ants, Monomorium pharaonis worker ants, Pheidole megacephala worker ants, and Coptotermes formosanus worker ants after 12 h of treatment with the 1-MOI pesticide. After application of the pesticide at a concentration of 0.14 μg/cm³ in space, 27%, 13%, 7%, 7%, 3%, 7%, 7%, 19%, and 10% Dorylus orientalis, Leptogenys kitteli, Tetramorium caespitum, Ochetellus glaber, Ectomomyrmex astutus worker ants, Monomorium chinense, Monomorium pharaonis, Pheidole megacephala worker ants, and Coptotermes formosanus worker ants, respectively were killed; when the concentration of 1-MOI was 0.28 μg/cm³ in space, 64%, 81%, 54%, 48%, 67%, 29%, 34%, 44%, and 41% of the above ants and termite, respectively were killed; and when the concentration of 1-MOI was 1.4 μg/cm³ in space, 100% of the above ants and termite were killed.

### 3. Killing Effect of 1-MOI Pesticides on Agricultural Pests

### (1) Test Method

The killing effect of the 1-MOI pesticide on Bemisia tabaci, Nilaparvata lugens Stal, Tetranychus cinnabarinus, Bactrocera dorsalis, Halyomorpha halys, Megalurothrips usitatus Bagnall, Frankliniella occidentalis Pergande, Thrips palmi, Tribolium castaneum Herbst, Orosius orientalis, and Tuta absoluta Meyrick using a residual film method was specifically implemented according to the same method as the test method (1) in Example 3.

### (2) Results

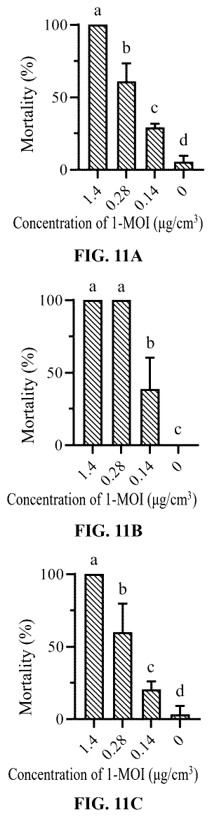

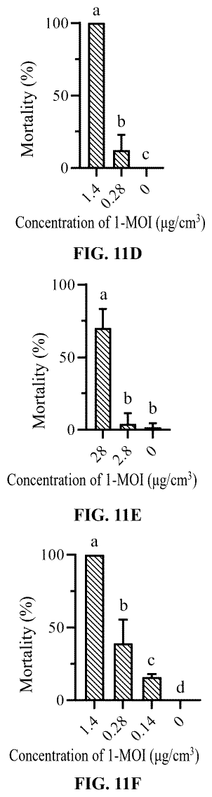

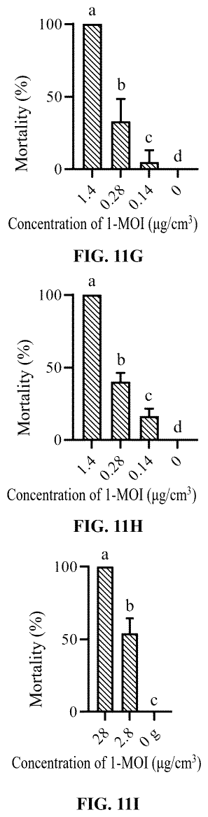

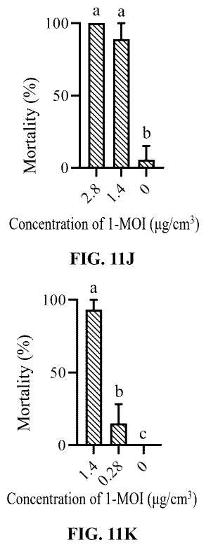

The results of the tests using a residual film method are shown in FIGS. 11A-11K. FIGS. 11A-11K, in order, respectively correspond to the mortality rate of Bemisia tabaci, Nilaparvata lugens Stal, Tetranychus cinnabarinus, Bactrocera dorsalis, Halyomorpha halys, Megalurothrips usitatus Bagnall, Frankliniella occidentalis Pergande, Thrips palmi, Tribolium castaneum Herbst, Orosius orientalis, and Tuta absoluta Meyrick after 12 h of treatment with the 1-MOI pesticide. After application of the pesticide at a concentration of 0.14 μg/cm³ in space, 29%, 39%, 21%, 16%, 5%, and 16% Bemisia tabaci, Nilaparvata lugens Stal, Tetranychus cinnabarinus, Megalurothrips usitatus Bagnall, Frankliniella occidentalis Pergande, and Thrips palmi were killed, respectively; when the concentration of 1-MOI was 0.28 μg/cm³ in space, 61%, 100%, 60%, 12%, 39%, 33%, 40%, and 15% Bemisia tabaci, Nilaparvata lugens Stal, Tetranychus cinnabarinus, Bactrocera dorsalis, Megalurothrips usitatus Bagnall, Frankliniella occidentalis Pergande, Thrips palmi, and Tuta absoluta Meyrick were killed, respectively; when the concentration of 1-MOI was 1.4 μg/cm³, 100% of Bemisia tabaci, Nilaparvata lugens Stal, Tetranychus cinnabarinus, Bactrocera dorsalis, Megalurothrips usitatus Bagnall, Frankliniella occidentalis Pergande, and Thrips palmi were killed, and 89% and 93% Orosius orientalis and Tuta absoluta Meyrick were killed, respectively; when the concentration of 1-MOI was 2.8 μg/cm³ in space, 54% and 100% Tribolium castaneum Herbst and Orosius orientalis were killed, respectively; and when the concentration of 1-MOI was 28 μg/cm³, 100% Orosius orientalis were killed, and 70% Halyomorpha halys were killed.

Based on the results described above, a 1-MOI concentration gradient was set in the present disclosure in the experiment for testing the repellent effect of the 1-MOI repellent on pests by Two-way choice test. As to the results, the total amount of 1-MOI contained in the filter paper is used as an indicator to show the repellent effect on pests. Taking the minimum effective total amount of 1-MOI as 0.1 μg as an example, the area of the filter paper is calculated as 0.5×0.5×3.14=0.785 cm², such that the concentration of 1-MOI in a plane=0.1/0.785=0.127 μg/cm² is calculated; and when the total amount of 1-MOI is 1 μg, the concentration of 1-MOI in the plane is 1.27 μg/cm², and so on. In the tests for testing the killing effect of the 1-MOI pesticide on pests using a residual film method in the present disclosure, the container of tissue culture flasks used has a volume of 350 mL, i.e., 350 cm³. Taking a total application amount of 1-MOI as 500 μg as an example, the concentration in space=500/350=0.14 μg/cm³, and so on.

Although the examples described above have provided a detailed description of the present disclosure, they are only a part of, rather than all of the examples of the present disclosure. All other examples that can be obtained according to the examples of the present disclosure without creative efforts shall fall within the scope of protection of the disclosure.

What is claimed is:

1. A method for killing or repelling an insect, comprising exposing insects or surfaces which are contacted by the insects to 1-methoxyindole (1-MOI) or a salt or a derivative thereof.

2. The method of claim 1, wherein the exposing is performed by spraying the insects or the surfaces which are contacted by the insect with a composition comprising an organic solvent with the 1-methoxyindole (1-MOI) or a salt or a derivative thereof dissolved or dispersed in the organic solvent.

3. The method of claim 1, wherein the insect comprises any one or more selected from the group consisting of Hymenoptera insects, Isoptera insects, Diptera insects, Acarina ticks, and Thysanoptera insects.

4. The method of claim 3, wherein the insect further comprises any one or more selected from the group consisting of Cimex lectularius, Periplaneta americana, Blattella germanica, Bemisia tabaci, Nilaparvata lugens Stal, Tetranychus cinnabarinus, Bactrocera dorsalis, Halyomorpha halys, Tribolium castaneum Herbst, Orosius orientalis, and Tuta absoluta Meyrick.

5. A method of preparing an insecticide, an insect repellent, or a composition having both repellent and pesticidal capabilities, comprising dissolving or distributing 1-methoxyindole (1-MOI) or a salt or a derivative thereof in an solvent.

6. The method of claim 5, wherein the solvent is an organic solvent.

7. An insecticide or repellant, comprising:
a solvent, and
1-methoxyindole (1-MOI) or a salt or a derivative thereof dissolved or dispersed in the solvent.

8. The insecticide or repellant of claim 7, wherein the solvent is an organic solvent.
